(19) United States
(12) Patent Application Publication
(10) Pub. No.: US 2020/0274402 A1
(43) Pub. Date: Aug. 27, 2020

(54) WIRELESS POWER RECEIVER CONTROLLING MAGNITUDE OF COMMUNICATION SIGNAL

(71) Applicant: MAPS, INC., Seoul (KR)

(72) Inventors: Jong Tae HWANG, Seoul (KR); Ki-Woong JIN, Anyang-si (KR); Sung Min PARK, Seoul (KR); Gi Won KANG, Incheon (KR); Hyun Ick SHIN, Seoul (KR); Joon RHEE, Seoul (KR)

(73) Assignee: MAPS, INC., Seoul (KR)

(21) Appl. No.: 16/305,070

(22) PCT Filed: Jul. 27, 2017
(86) PCT No.: PCT/KR2017/008085

§ 371 Date: Nov. 28, 2018

(30) Foreign Application Priority Data
Jul. 27, 2016 (KR) 10-2016-0095548
Dec. 2, 2016 (KR) 10-2016-0163749

(51) Int. Cl. H02J 50/80; H02J 50/10; H02H 3/20; H02M 7/06

(52) U.S. Cl. CPC H02J 50/80; H02M 7/06; H02H 3/20; H02J 50/10

(57) ABSTRACT

Disclosed is a wireless power receiver that controls a level of a communication signal. A wireless power receiver according to an embodiment includes a resonator for receiving wireless power, a rectifier for converting an alternating current power received from the resonator to a direct current power and outputting a rectifier output voltage, a switch for receiving a communication signal and controlling a rectifier output voltage through switching, and a regulator for adjusting a voltage change of a rectifier output voltage by modulating a communication signal.

### TECHNICAL FIELD

The present invention relates to a wireless power transmission technique.

### BACKGROUND ART

A wireless power transmitter wirelessly transmits power to a wireless power receiver through an antenna. In this operation, the frequency at which the antenna is driven depends on the wireless power transfer (WPT) standards. There are various WPT standards. For example, the WPT standards include a Qi scheme and a Power Matters Alliance (PMA) scheme by the Wireless Power Consortium (WPC). The WPT standards also include an Alliance for Wireless Power (A4WP) scheme.

### DISCLOSURE

### Technical Problem

The present invention is directed to providing a wireless power receiver capable of addressing communication problems that may occur due to excessive change in output voltage of a rectifier of a receiver causing change in output voltage of the receiver or due to increase of the output voltage of the rectifier to an over-voltage protection level when a transmitter communicates with the receiver using an amplitude modulation technique such as the Qi scheme in the wireless power transmission system.

### Technical Solution

One aspect of the present invention provides a wireless power receiver including a resonator configured to receive wireless power, a rectifier configured to convert alternating current power received from the resonator into direct current power and output a rectifier output voltage, a switch configured to receive a communication signal and control the rectifier output voltage through switching, and a regulator configured to control voltage variation of the rectifier output voltage by modulating the communication signal.

The regulator may regulate a level of the rectifier output voltage to a constant level using the modulated communication signal obtained by modulating the communication signal in order to prevent the rectifier output voltage from decreasing and causing variation of a receiver output voltage and to prevent the rectifier output voltage from increasing beyond an over-voltage protection level and causing a communication problem due to an over-voltage protection function.

During communication, the regulator may control a maximum level of the rectifier output voltage such that the rectifier output voltage is not higher than a preset maximum voltage and may control a minimum level of the rectifier output voltage such that the rectifier output voltage is not lower than a preset minimum voltage.

The regulator may include a rectifier output voltage detection circuit configured to detect the rectifier output voltage, a comparator configured to compare the detected rectifier output voltage with a reference voltage and output a comparator output signal according to the comparison, and a logic AND circuit configured to perform an AND logic operation on the comparator output signal and the communication signal to output the modulated communication signal and to cause the switch to be turned on and off by the modulated communication signal. When the comparator output signal is LOW, which indicates that the rectifier output voltage is higher than a preset maximum voltage or lower than a preset minimum voltage, the modulated communication signal may become LOW to turn the switch off even when the communication signal is set to be HIGH by the logic AND circuit such that the rectifier output voltage returns to a state in which the rectifier output voltage was set prior to application of the communication signal and converges into a range between the maximum voltage and the minimum voltage without increasing beyond the maximum voltage or decreasing below the minimum voltage, when the rectifier output voltage converges into the range between the maximum voltage and the minimum voltage, the comparator output signal may become HIGH again and cause the logic AND circuit to turn on the switch to maintain an intended communication state, and wherein, when the rectifier output voltage reaches the maximum voltage or the minimum voltage during a communication period, the rectifier output voltage may be regulated within a reference voltage range by repeatedly turning the switch on and off.

The regulator may include a rectifier output voltage detection circuit configured to detect the rectifier output voltage; a first comparator configured to compare the detected rectifier output voltage with a first reference voltage and output a first comparator output signal according to the comparison; a second comparator configured to compare the rectifier output voltage detected through the rectifier output voltage detection circuit with a second reference voltage and output a second comparator output signal, the second reference voltage being higher than the first reference voltage; a first logic AND circuit configured to perform an AND logic operation on the first comparator output signal and the second comparator output signal to output an AND output signal; and a second logic AND circuit configured to perform the AND logic operation on the AND output signal and the communication signal to output the modulated communication signal to turn the switch on and off. When the rectifier output voltage is higher than the second reference voltage, the first comparator output signal may become LOW and the AND output signal output by the first logic AND circuit may become LOW to cause the modulated communication signal output through the second logic AND circuit to become LOW even when the communication signal is HIGH to turn the switch off such that the regulator reduces the rectifier output voltage.

The regulator may include: a communication packet duration detector configured to detect the communication signal and generate a sample strobe signal; a sample and hold unit configured to detect the rectifier output voltage using the sample strobe signal to sample a sample signal and generate and hold a first reference voltage and a second reference voltage using the sample signal, the second reference voltage being higher than the first reference voltage; a first comparator configured to receive and compare the first reference voltage and the rectifier output voltage and output a first comparator output signal according to the comparison; a second comparator configured to receive and compare the second reference voltage and the rectifier output voltage and output a second comparator output signal according to the comparison; a first logic AND circuit configured to output a clamp signal by performing an AND logic operation on the first comparator output signal and the second comparator output signal; and a second logic AND circuit configured to output the modulated communication signal by performing the AND logic operation on the clamp signal and the communication signal. The first reference voltage may be a preset minimum voltage, and the second reference voltage may be a preset maximum voltage, wherein, during communication, the regulator may control a minimum level of the rectifier output voltage such that the rectifier output voltage is not lower than the first reference voltage and may control a maximum level of the rectifier output voltage such that the rectifier output voltage is not higher than the second reference voltage.

The wireless power receiver may perform in-band communication in wireless charging based on a Qi scheme.

### Advantageous Effects

According to an embodiment, as a communication signal is modulated in a wireless power transfer (WPT) system and the magnitude of a rectifier output voltage is constantly regulated using the modulated communication signal, the receiver output voltage may be prevented from being varied due to decrease in the rectifier output voltage and communication problems may be prevented from occurring due to an over-voltage protection function according to increase of the rectified output voltage beyond an over-voltage protection level. In particular, the proposed technique can be employed when communication is performed between a transmitter and a receiver using an amplitude modulation technique such as the Qi scheme.

### DESCRIPTION OF DRAWINGS

FIG. 1 is a configuration diagram of a wireless power transmission system according to one embodiment of the present invention.

FIG. 2 is a waveform diagram illustrating voltage variation of a rectifier output voltage VRECT during communication of a receiver.

FIG. 3 is a waveform diagram illustrating a situation in which a receiver output voltage Vout is changed due to excessive reduction of the rectifier output voltage VRECT during communication of the receiver.

FIG. 4 is a waveform diagram illustrating a situation in which the rectifier output voltage VRECT of the receiver is increased over an over-voltage protection (OVP) level during communication of the receiver.

FIG. 5 is a configuration diagram of a receiver including a regulator configured to control a level of a rectifier output voltage through modulation of a communication signal according to a first embodiment of the present invention.

FIG. 6 is a waveform diagram obtained when the circuit of FIG. 5 operates according to one embodiment of the present invention.

FIG. 7 is a configuration diagram of a receiver including a regulator configured to control a level of a rectifier output voltage through modulation of a communication signal according to a second embodiment of the present invention.

FIG. 8 is a waveform diagram for explaining the effect of the circuit of FIG. 7 according to one embodiment of the present invention.

FIG. 9 is a configuration diagram of a receiver including a regulator configured to control a magnitude of a rectifier output voltage through modulation of a communication signal according to a third embodiment of the present invention.

FIG. 10 is an operation waveform diagram of the circuit of FIG. 9 according to one embodiment of the present invention.

FIG. 11 is an experimental waveform diagram of an operation of controlling the minimum voltage of a rectifier output voltage VRECT during communication according to one embodiment of the present invention.

### MODES OF THE INVENTION

Advantages and features of the present invention and methods to achieve the same will become apparent from the detailed descriptions of exemplary embodiments herein below with reference to the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art. The present invention is only defined by the claims. Like reference numerals designate like elements throughout the specification.

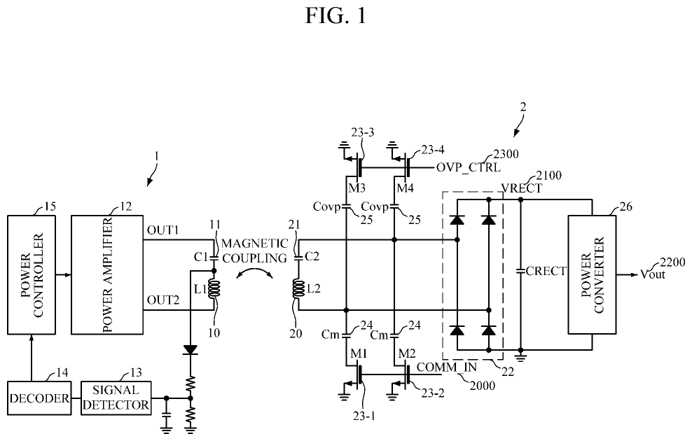

FIG. 1 is a configuration diagram of a wireless power transmission system according to one embodiment of the present invention.

Referring to FIG. 1, the wireless power transmission system includes a transmitter 1 configured to wirelessly transmit a power signal and a receiver 2 configured to wirelessly receive the power signal. There are various wireless power transmission schemes, but in the present invention, the description will be given mainly based on the Qi scheme proposed by the Wireless Power Consortium (WPC). The Qi scheme is a technique for performing communication by changing an amplitude, and any scheme can be employed as long as it allows communication by changing the amplitude similarly to the Qi scheme. The wireless power transmission system may perform in-band communication in wireless charging based on the Qi scheme.

The transmitter 1 changes power transmitted from a power amplifier 12 to wireless power through a resonator including an inductor L1 10 and a resonant capacitor C1 11. The changed power is converted into an electric field to induce a current in an inductor L2 20 of the receiver 2, which is magnetically coupled to the transmitter 1. In order to efficiently receive power from the transmitter 1, the receiver 2 uses a resonant capacitor C2 21 to tune a resonant frequency obtained by the inductor L2 20 and the resonant capacitor C2 21 to a resonance frequency obtained by the inductor L1 10 and the resonance capacitor C1 11.

The current through the inductor L2 20 is an alternating current (AC). A rectifier 22 is used to change the AC current to a direct current (DC) rectifier output voltage VRECT 2100. As shown in FIG. 1, the rectifier 22 may be a passive rectifier using a diode, but the same operation and effect can be obtained even with an active rectifier using a switch element. Since the rectifier output voltage VRECT 2100 is a DC voltage but is an uncontrolled voltage, it is necessary to change the rectifier output voltage VRECT to a precise voltage desired by a load. Therefore, a DC-DC power converter 26 is used to generate a correct receiver output voltage Vout 2200. The power converter 26 is a switching converter such as a buck converter, but a linear regulator such as a low-dropout (LDO) regulator can also be used.

The transmitter 1 and the receiver 2 communicate with each other. The transmitter 1 and the receiver 2 may process or transmit/receive a packet composed of a predetermined frame. The receiver 2 may be, for example, a mobile communication terminal, a personal digital assistant (PDA), a portable multimedia player (PMP), a smartphone, or the like. The receiver 2 may transmit, to the transmitter 2, a signal for requesting wireless power transmission, information required for wireless power reception, receiver state information, transmitter control information, and the like.

It is necessary to control the power of the transmitter 1 according to the power required by the load. Therefore, the receiver 2 makes a request to the transmitter 1 for power through communication. The communication may be performed in a manner similar to Amplitude Shift Keying (ASK). As shown in FIG. 1, when a switch M1 23-1 and a switch M2 23-2 are turned on by a communication signal COMM_IN, a capacitor Cm 24 connected to the switches M1 23-1 and M2 23-2 changes the resonance frequency, causing voltage variation in the inductor L2 20. Since the inductor L2 20 and the inductor L1 10 are magnetically coupled, the voltage variation also occurs in the inductor L1 10. When the transmitter 1 outputs a digital signal by sensing and filtering the voltage variation in the inductor L1 10 using a diode, a resistor, a capacitor, and the like, a signal detector 13 receives the digital signal and transfers the digital signal to the decoder 14. The decoder 14 analyzes the signal and a power controller 15 controls output power OUT1 or OUT2 of the power amplifier 12 according to results of the analysis in the decoder 14.

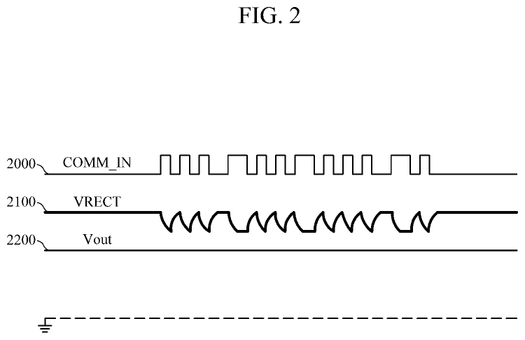

FIG. 2 is a waveform diagram illustrating voltage variation of a rectifier output voltage VRECT during communication of a receiver.

Referring to FIGS. 1 and 2, when the receiver 2 performs communication, the voltage variation caused by the switches M1 23-1 and M2 23-2 causes not only a voltage variation in the inductor L2 20 but also a voltage variation of the rectifier output voltage VRECT 2100 as shown in FIG. 2. FIG. 2 shows an example in which the rectifier output voltage VRECT 2100 is reduced by the communication signal COMM_IN 2000. In this case, the rectifier output voltage VRECT 2100 decreases only so as not to affect the operation of the power converter 26, and therefore the receiver output voltage Vout 2200 does not change.

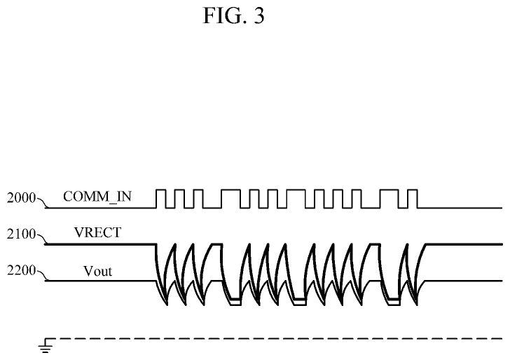

FIG. 3 is a waveform diagram illustrating a situation in which a receiver output voltage Vout is changed due to excessive reduction of the rectifier output voltage VRECT during communication of the receiver.

Referring to FIGS. 1 and 3, when the capacity of the capacitor Cm 24 is large, or when the resonance characteristic changes during communication, the rectifier output voltage VRECT 2100 may be excessively reduced as shown in FIG. 3. As the rectifier output voltage VRECT 2100 decreases below the receiver output voltage Vout 2200, the receiver output voltage Vout 2200 decreases in synchronization with the communication signal COMM_IN 2000. In this case, the receiver output voltage Vout 2200 is not regulated, which has a negative influence such as causing noise in the system connected to the receiver output voltage Vout 2200, and the output power is lowered due to a decrease in the receiver output voltage Vout 2200.

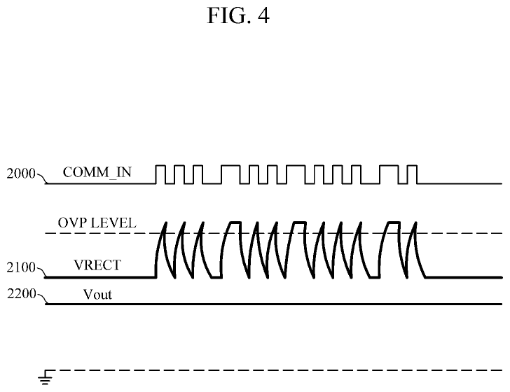

FIG. 4 is a waveform diagram illustrating a situation in which the rectifier output voltage VRECT of the receiver is increased over an over-voltage protection (OVP) level during communication of the receiver.

Referring to FIGS. 1 and 4, the variation in the resonance frequency during communication affects not only the capacity of the capacitor Cm 24 but also the output power of the receiver, and, rather than decreasing, the rectifier output voltage VRECT 2100 is increased in the case of a light load. This is the case of FIG. 4. When the rectifier output voltage VRECT 2100 excessively increases and is higher than the OVP level for protecting the receiver 2, the OVP_CTRL signal 230 of FIG. 1 becomes HIGH. Then, the switches M3 23-3 and M4 23-4 are turned on by the OVP_CTRL signal 230 and cause the excessive energy supplied to the rectifier 22 to drain through a capacitor Covp 25 to reduce the rectifier output voltage VRECT 2100. Then, the rectifier input voltage is lowered, which changes the voltage of the inductor L2 20. Thus, in the transmitter 1, the OVP_CTRL signal 230 acts as another communication signal. The problem is that the transmitter 1 cannot recognize the OVP_CTRL signal 230 because the OVP_CTRL signal 230 is not a signal generated by a coding standard, while the communication signal COMM_IN 2000 is a signal generated by the coding standard. Therefore, when the above-described phenomenon is repeated, the transmitter 1 interrupts supplied power and stops its operation. As a result, wireless power transmission is not performed.

The present invention is intended to prevent the rectifier output voltage VRECT 2100 from excessively decreasing and degrading the output power and to suppress excessive increase of the rectifier output voltage VRECT 2100 so as to not cause communication problems due to the OVP function by appropriately controlling fluctuation of the rectifier output voltage VRECT 2100 during communication of the receiver in a wireless power transmission system that performs communication using the Qi scheme or a similar scheme for performing communication by changing the amplitude.

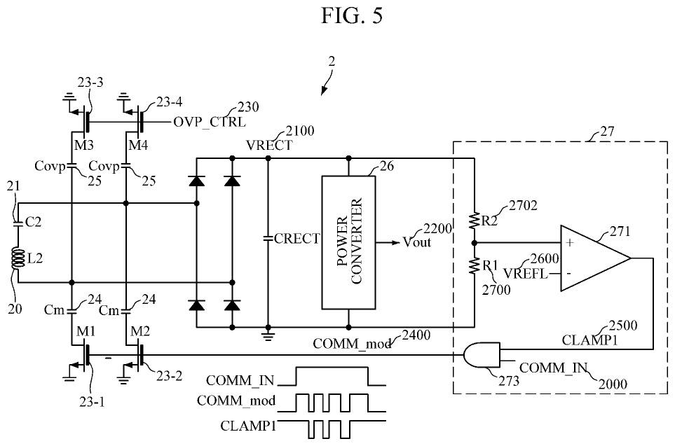

FIG. 5 is a configuration diagram of a receiver including a regulator configured to control a level of a rectifier output voltage through modulation of a communication signal according to a first embodiment of the present invention.

Referring to FIG. 5, the regulator 27 regulates the level of the rectifier output voltage VRECT 2100 to prevent the rectifier output voltage VRECT 2100 from being excessively lowered as shown in FIG. 3. To this end, the regulator 27 includes a rectifier output voltage detection circuit, a comparator 271 and a logic AND circuit 273.

The rectifier output voltage detection circuit, which is configured to detect the rectifier output voltage VRECT 2100, may include, for example, resistors R1 2700 and R2 2702 as shown in FIG. 5. The comparator 271 compares the rectifier output voltage VRECT 2100 detected by the resistors R1 2700 and R2 2702 with a reference voltage VREFL 2600 and outputs a comparator output signal CLAMP1 2500 according to the comparison.

The regulator 27 controls the switches M1 23-1 and M2 23-2 using a modulated communication signal COMM_mod 2400 rather than the communication signal COMM_IN 2000. The modulated communication signal COMM_mod 2400 becomes LOW when the rectifier output voltage VRECT 2100 satisfies the condition below. The condition under which a comparator output signal CLAMP1 2500 becomes LOW is as follows.

VRECT<(1+R2/R1)×VREFL

When the comparator output signal CLAMP1 2500 is LOW, which indicates that the rectifier output voltage VRECT 2100 is higher than a preset maximum voltage or lower than a preset minimum voltage, the modulated communication signal COMM_mod 2400, which is the output signal of the logic AND circuit 273, becomes LOW even when the communication signal COMM_IN 2000 is HIGH. When the modulated communication signal COMM_mod 2400 is LOW, the switches M1 23-1 and M2 23-2 are turned off. Then, the rectifier output voltage VRECT 2100 returns to a state in which the rectifier output voltage VRECT 2100 was set prior to application of the communication signal COMM_IN 2000 without increasing beyond the maximum voltage or decreasing below the minimum voltage. Accordingly, the rectifier output voltage VRECT 2100 converges into a range between the maximum voltage and the minimum voltage.

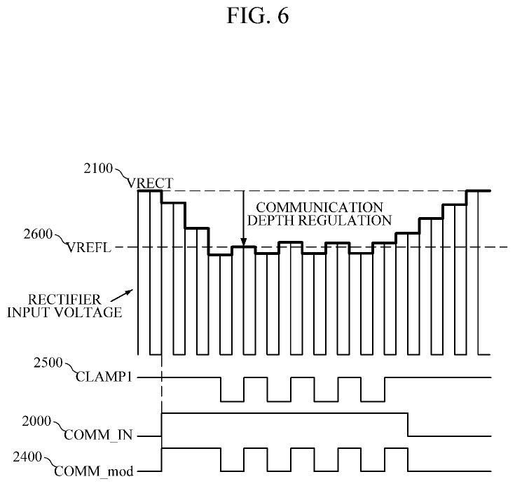

When the rectifier output voltage VRECT 2100 converges into the range between the maximum voltage and the minimum voltage, the comparator output signal CLAMP1 2500 becomes HIGH again. Thus, in this case, the communication signal COMM_IN 2000 is transmitted to the switches M1 23-1 and M2 23-2 by the logic AND circuit 273 to turn on the switches M1 23-1 and M2 23-2 to maintain the intended communication state. When the rectifier output voltage VRECT 2100 reaches the maximum voltage or the minimum voltage during a communication period, the above-described process is repeated such that the rectifier output voltage VRECT 2100 is regulated to be (1+R2/R1)×VREFL. The above-described operation has an operation waveform as shown in FIG. 6.

FIG. 6 is a waveform diagram obtained when the circuit of FIG. 5 operates according to one embodiment of the present invention.

As shown in FIG. 6, it can be seen that the rectifier output voltage VRECT 2100 is kept constant through communication depth regulation by the modulated communication signal COMM_mod 2400 obtained by modulating the communication signal COMM_IN 2100.

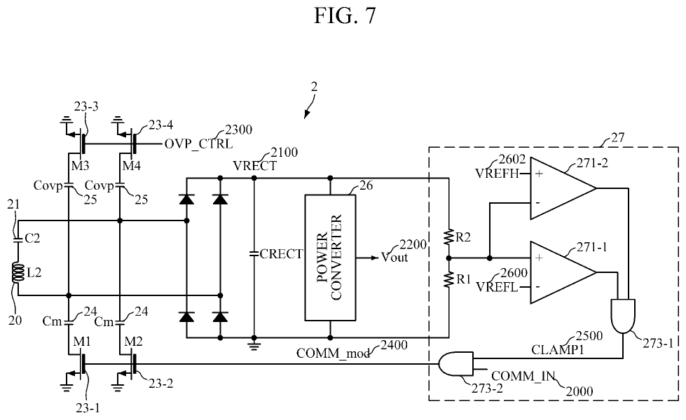

The circuit of FIG. 5 may be extended to suppress an excessive increase of the rectifier output voltage VRECT 2100 during communication. A circuit that performs an extended operation is show in FIG. 7.

FIG. 7 is a configuration diagram of a receiver including a regulator configured to control a level of a rectifier output voltage through modulation of a communication signal according to a second embodiment of the present invention.

Referring to FIG. 7, the regulator 27 controls the minimum voltage and the maximum voltage of the rectifier output voltage VRECT 2100 during communication of the receiver 2. To this end, the regulator 27 includes a rectifier output voltage detection circuit, a first comparator 271-1, a second comparator 271-2, a first logic AND circuit 273-1, and a second logic AND circuit 273-2.

The second comparator 271-2 compares the rectifier output voltage VRECT 2100 detected by the rectifier output voltage detection circuit with a second reference voltage VREFH 2602 and outputs a second comparator output signal. The second reference voltage VREFH 2602 is higher than a first reference voltage VREFL 2600. The first logic AND circuit 273-1 performs an AND operation on the first comparator output signal and the second comparator output signal to output a CLAMP1 signal 2500. The second logic AND circuit 273-2 performs an AND operation on the CLAMP1 signal 2500 and the communication signal COMM_IN 2000 to output the modulated communication signal COMM_mod 2400. The switches M1 23-1 and M2 23-2 are turned on and off by the modulated communication signal COMM_mod 2400.

When the rectifier output voltage VRECT 2100 is higher than VREFH×(1+R2/R1) (when VRECT>VREFH×(1+R2/R1)), the first comparator output signal becomes LOW. Then, since the signal CLAMP1 2500 output by the first logic AND circuit 273-1 becomes LOW. Accordingly, even if the communication signal COMM_IN 2000 is HIGH, the switches M1 23-1 and M2 23-2 are turned off, and the rectifier output voltage VRECT 2100 returns to the resonance characteristic obtained before application of the communication signal COMM_IN 2000 and is thus lowered.

When the rectifier output voltage VRECT 2100 before the communication is lower than VREFH×(1+R2/R1) and the rectifier output voltage VRECT 2100 is lowered by the communication signal COMM_IN 2000, communication may be disabled. Similarly, communication may be disabled when the rectifier output voltage VRECT 2100 before the communication is higher than VREFH×(1+R2/R1) and the rectifier output voltage VRECT 2100 increases during the communication. A protection circuit to prevent such cases is required. The protection circuit is beyond the scope of the present invention, and various methods are available for implementing the protection circuit. Therefore, the protection circuit will not be introduced in the present invention

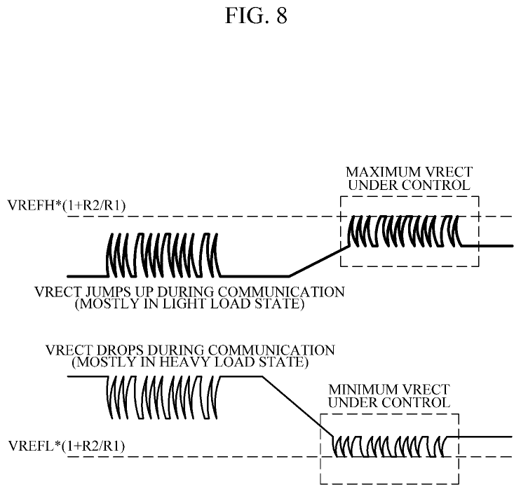

FIG. 8 is a waveform diagram for explaining the effect of the circuit of FIG. 7 according to one embodiment of the present invention.

Referring to FIG. 8, during communication of the receiver, the maximum level of the rectifier output voltage VRECT 2100 is controlled such that the rectifier output voltage VRECT 2100 is not higher than VREFH×(1+R2/R1), and the minimum level of the rectifier output voltage VRECT 2100 is controlled such that the rectifier output voltage VRECT 2100 is not lower than VREFH×(1+R2/R1). The rectifier output voltage VRECT 2100 jumps up mostly in a light load state and drops mostly in a heavy load state.

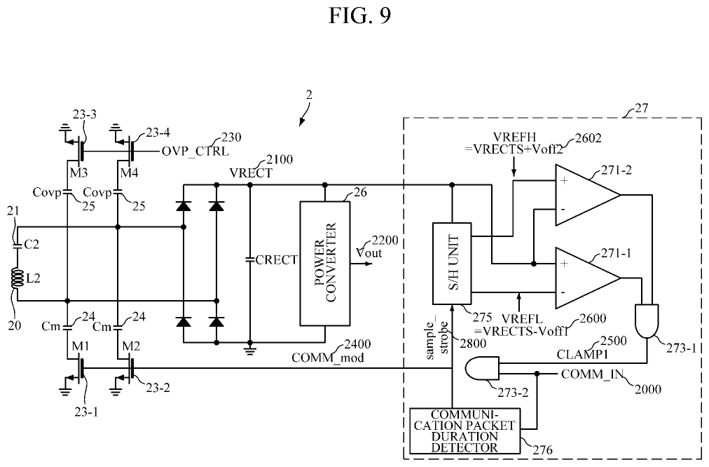

FIG. 9 is a configuration diagram of a receiver including a regulator configured to control a magnitude of a rectifier output voltage through modulation of a communication signal according to a third embodiment of the present invention.

Referring to FIG. 9, the regulator 27 dynamically controls the voltage variation of the rectifier output voltage VRECT 2100 during communication of the receiver. The regulator may keep the variation of the rectifier output voltage VRECT 2100 constant during communication through the dynamic control. To this end, the regulator 27 includes a first comparator 271-1, a second comparator 271-2, a first logic AND circuit 273-1, a second logic AND circuit 273-2, a sample and hold (S/H) unit 275 and a communication packet duration detector 276.

The communication packet duration detector 276 generates a sample strobe signal sample_strobe 2800 at the start of communication. The S/H unit 275 detects the rectifier output voltage VRECT 2100 using the sample strobe signal sample_strobe 2800 and generates a sample signal VRECTS. The S/H unit 275 generates and holds two reference voltages VREFH 2602 and VREFL 2600 using the sample signal VRECTS. The second reference voltage VREFH 2602 is VRECTS+Voff2, and the first reference voltage VREFL 2600 is VRECTS−Voff1.

The first comparator 271-1 receives and compares the first reference voltage VREFL 2600 and the rectifier output voltage VRECT 2100 and outputs a first comparator output signal according to the comparison. The second comparator 272-2 receives and compares the second reference voltage VREFH 2602 and the rectifier output voltage VRECT 2100 and outputs a second comparator output signal according to the comparison. The first logic AND circuit 273-1 outputs a clamp signal CLAMP1 2500 by performing an AND logic operation on the first comparator output signal and the second comparator output signal. The second logic AND circuit 273-2 outputs the modulated communication signal COMM_mod 2400 by performing the AND logic operation on the clamp signal CLAMP1 2500 and the communication signal COMM_IN 2000. Therefore, the rectifier output voltage VRECT 2100 cannot increase beyond VERCTS+Voff2. Nor can it decrease below VRECTS−Voff1.

The S/H unit 275 of FIG. 9 may be implemented using a capacitor or using an analog-to-digital (A/D) converter (ADC) and a digital-to-analog (D/A) converter (DAC). In other words, it will be understood that the S/H unit can be implemented using various implementation methods and operate according to the above-described concept.

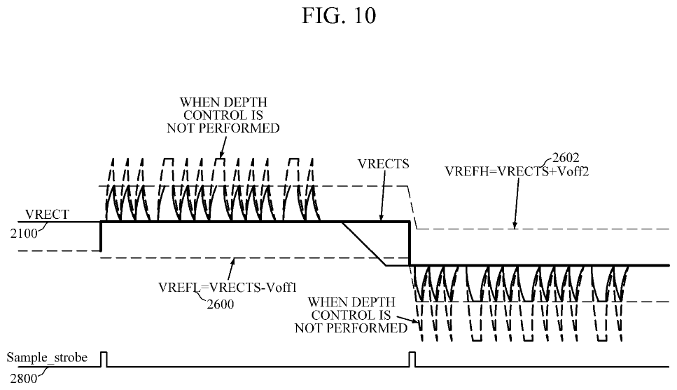

FIG. 10 is an operation waveform diagram of the circuit of FIG. 9 according to one embodiment of the present invention.

Referring to FIG. 10, by controlling the level of the rectifier output voltage VRECT 2100, the rectifier output voltage VRECT 2100 may be controlled to be lower than VERCTS+Voff2 and higher than VRECTS−Voff1 during communication.

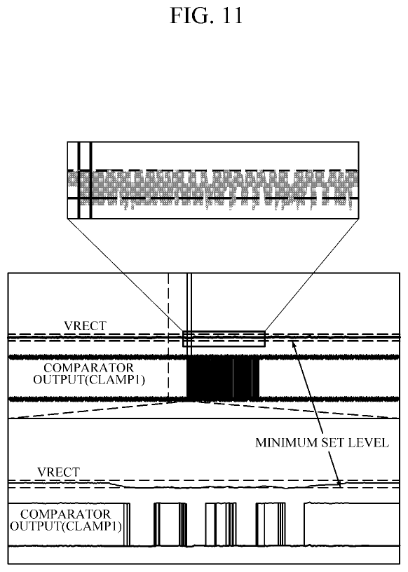

FIG. 11 is an experimental waveform diagram of an operation of controlling the minimum voltage of a rectifier output voltage VRECT during communication according to one embodiment of the present invention.

Referring to FIG. 11, it can be seen that the rectifier output voltage VRECT may be controlled so as to not be lower than the minimum voltage by controlling the minimum voltage of the rectifier output voltage VRECT during communication of the receiver.

The embodiments of the present invention have been described above. It will be understood by those skilled in the art that various changes in form and details can be made in the present invention without departing from the spirit and scope of the invention as defined by the appended claims. Therefore, the disclosed embodiments should be considered in an illustrative rather than restrictive sense. The scope of the present invention is defined by the appended claims rather than by the foregoing description, and all differences within the scope of equivalents thereof should be construed as being included in the present invention.

1. A wireless power receiver comprising:
a resonator configured to receive wireless power;
a rectifier configured to convert alternating current power received from the resonator into direct current power and output a rectifier output voltage;
a switch configured to receive a communication signal and control the rectifier output voltage through switching; and
a regulator configured to control voltage variation of the rectifier output voltage by modulating the communication signal.

2. The wireless power receiver of claim 1, wherein the regulator regulates a level of the rectifier output voltage to a constant level using the modulated communication signal obtained by modulating the communication signal, in order to prevent the rectifier output voltage from decreasing and causing variation of a receiver output voltage and to prevent the rectifier output voltage from increasing beyond an over-voltage protection level and causing a communication problem due to an over-voltage protection function.

3. The wireless power receiver of claim 1, wherein, during communication, the regulator controls a maximum level of the rectifier output voltage such that the rectifier output voltage is not higher than a preset maximum voltage and controls a minimum level of the rectifier output voltage such that the rectifier output voltage is not lower than a preset minimum voltage.

4. The wireless power receiver of claim 1, wherein the regulator comprises:
a rectifier output voltage detection circuit configured to detect the rectifier output voltage;
a comparator configured to compare the detected rectifier output voltage with a reference voltage and output a comparator output signal according to the comparison; and
a logic AND circuit configured to perform an AND logic operation on the comparator output signal and the communication signal to output the modulated communication signal and to cause the switch to be turned on and off by the modulated communication signal.

5. The wireless power receiver of claim 4, wherein, when the comparator output signal is LOW, which indicates that the rectifier output voltage is higher than a preset maximum voltage or lower than a preset minimum voltage, the modulated communication signal becomes LOW even when the communication signal is set to be HIGH by the logic AND circuit to turn the switch off such that the rectifier output voltage returns to a state in which the rectifier output voltage was set prior to application of the communication signal and converges into a range between the maximum voltage and the minimum voltage without increasing beyond the maximum voltage or decreasing below the minimum voltage,
wherein, when the rectifier output voltage converges into the range between the maximum voltage and the minimum voltage, the comparator output signal becomes HIGH again and causes the logic AND circuit to turn on the switch to maintain an intended communication state, and
wherein, when the rectifier output voltage reaches the maximum voltage or the minimum voltage during a communication period, the rectifier output voltage is regulated within a reference voltage range by repeatedly turning the switch on and off.

6. The wireless power receiver of claim 1, wherein the regulator comprises:
a rectifier output voltage detection circuit configured to detect the rectifier output voltage;
a first comparator configured to compare the detected rectifier output voltage with a first reference voltage and output a first comparator output signal according to the comparison;
a second comparator configured to compare the rectifier output voltage detected through the rectifier output voltage detection circuit with a second reference voltage and output a second comparator output signal, the second reference voltage being higher than the first reference voltage;
a first logic AND circuit configured to perform an AND logic operation on the first comparator output signal and the second comparator output signal to output an AND output signal; and
a second logic AND circuit configured to perform the AND logic operation on the AND output signal and the communication signal to output the modulated communication signal to turn the switch on and off.

7. The wireless power receiver of claim 6, wherein, when the rectifier output voltage is higher than the second reference voltage, the first comparator output signal becomes LOW, and the AND output signal output by the first logic AND circuit becomes LOW to cause the modulated communication signal output through the second logic AND circuit to become LOW even when the communication signal is HIGH to turn the switch off such that the regulator reduces the rectifier output voltage.

8. The wireless power receiver of claim 1, wherein the regulator comprises:
a communication packet duration detector configured to detect the communication signal and generate a sample strobe signal;
a sample and hold unit configured to detect the rectifier output voltage using the sample strobe signal to sample a sample signal and generate and hold a first reference voltage and a second reference voltage using the sample signal, the second reference voltage being higher than the first reference voltage;
a first comparator configured to receive and compare the first reference voltage and the rectifier output voltage and output a first comparator output signal according to the comparison;
a second comparator configured to receive and compare the second reference voltage and the rectifier output voltage and output a second comparator output signal according to the comparison;
a first logic AND circuit configured to output a clamp signal by performing an AND logic operation on the first comparator output signal and the second comparator output signal; and
a second logic AND circuit configured to output the modulated communication signal by performing the AND logic operation on the clamp signal and the communication signal.

9. The wireless power receiver of claim 8, wherein the first reference voltage is a preset minimum voltage, and the second reference voltage is a preset maximum voltage,
wherein, during communication, the regulator controls a minimum level of the rectifier output voltage such that the rectifier output voltage is not lower than the first reference voltage and controls a maximum level of the rectifier output voltage such that the rectifier output voltage is not higher than the second reference voltage.

10. The wireless power receiver of claim 1, wherein the wireless power receiver performs in-band communication based on a Qi scheme in wireless charging.
